(19) United States
(12) Patent Application Publication
(10) Pub. No.: US 2015/0311008 A1
(43) Pub. Date: Oct. 29, 2015

(54) Case For Remote Control Units

(71) Applicant: Engineering Design Agency Limited, London (GB)

(72) Inventor: Paolo Nadalet, Modena (IT)

(21) Appl. No.: 14/443,700

(22) PCT Filed: Nov. 19, 2013
(86) PCT No.: PCT/IB2013/002589

§ 371 Date: May 19, 2015

(30) Foreign Application Priority Data
Nov. 20, 2012 (IT) MO2012A0000282

(51) Int. Cl. H01H 9/02

(52) U.S. Cl. CPC H01H 9/0242

(57) ABSTRACT

This invention relates to a case (1) for remote control units having a cover wrapping (2) for covering the substantial totality of a remote control unit (T) having at least a pushbutton panel (P), the cover wrapping (2) includes at least a sector which is at least partially transparent and can be placed in correspondence to the pushbutton panel (P) of the remote control unit (T) to permit the view of the pushbutton panel (P). The case (1) includes at least a covering element (9) which is associated in a removable way with the cover wrapping (2) substantially in correspondence to the sector and suitable for preventing the pushbutton panel (P) from being viewed as long as the covering element (9) is not removed from the cover wrapping (2).

### TECHNICAL FIELD

The present invention relates to a case for remote control units.

### BACKGROUND ART

It is known that an investigation into the hygiene of hotel rooms has shown that, contrary to all expectations, the cleanest part of the room is the bathroom, inasmuch as this is washed and sanitized continuously, while the dirtiest and most infected by germs, bacteria or pathogens of various type is the remote control unit of the TV set.

The remote control units of TV sets in fact come into contact with the hands of various hotel bedroom users without hardly ever being cleaned or sanitized, including because of the fact that they contain particularly delicate electronic devices which do not permit washing them using traditional detergents but which call for specific devices, the prolonged use of which however damages the remote control unit and reduces its life span.

The patent documents FR 2 762 922, U.S. Pat. No. 6,817,470, US 2008/0121541 and WO 2008/091700 illustrate a series of possible remote control cases designed to provide a hygiene barrier against the proliferation of germs and bacteria.

The cases made this way generally consist of a covering that envelops the remote control unit and prevents the user from coming into direct contact with the keys of the remote control unit.

These cases of known type do however have a number of drawbacks including the fact that, to ensure an effective barrier against the proliferation of germs and bacteria, they have to be changed and replaced fairly frequently (at least once for each hotel bedroom user) but, due to the negligence or the forgetfulness of the cleaning staff, this operation is not always performed.

In this circumstance, in practice, traditional cases completely lose their hygienic-protection function because the prolonged use of the same case has the same risk of germ and bacteria propagation as remote control units without any case whatsoever.

To this must be added that, even if the case is replaced according to the correct frequency, the hotel bedroom user cannot in any case be certain that such operation has actually been performed and that the case of his/her control unit has never been previously used.

Traditional cases in fact are unable to provide any indication or signal suitable for ensuring and guaranteeing they have only ever been used by just one user.

### DESCRIPTION OF THE INVENTION

The main aim of the present invention is to provide a case for remote control units which is in fact of the “disposable” type and can only be used by one user.

Within the scope of such technical aim, a further object of the present invention is to provide a case for remote control units that permits certifying and guaranteeing to the user that such case is single-use and that he/she is using it for the first time.

Another object of the present invention is to provide a case for remote control units which allows to overcome the mentioned drawbacks of the state of the art within the ambit of a simple, rational, easy and effective to use as well as low cost solution.

The above objects are reached by the present case for remote control units, according to claim 1.

### BRIEF DESCRIPTION OF THE DRAWINGS

Other characteristics and advantages of the present invention will become more evident from the description of a preferred, but not sole, embodiment of a case for remote control units, illustrated purely as an example but not limited to the annexed drawings in which:

FIG. 1 is an axonometric view of the case according to the invention before use;

FIG. 2 is a section view of the case according to the invention in which a remote control unit is fitted;

FIGS. 3a and 3b are two section views of the case according to the invention in a closing configuration, in which two remote control units having different dimensions are fitted;

FIG. 4 is an axonometric view of the case according to the invention during the removal of the covering element;

FIG. 5 is an axonometric view of the case according to the invention after use.

### EMBODIMENTS OF THE INVENTION

With particular reference to such figures, globally indicated by 1 is a case for remote control units.

The case 1 is meant to be used together with a remote control unit T of the type comprising a pushbutton panel P to give specific commands to an electronic appliance V.

In the particular embodiment shown in the figures, the remote control unit T is of the “cable” type, i.e. it is connected to the electronic appliance V through an electric wire F.

Alternative embodiments cannot however be ruled out in which the remote control unit T is of the “wireless” type and has an element for the emission of a wireless signal, e.g. a light signal, an electromagnetic wave or a combination of electromagnetic waves for the control of the electronic appliance V.

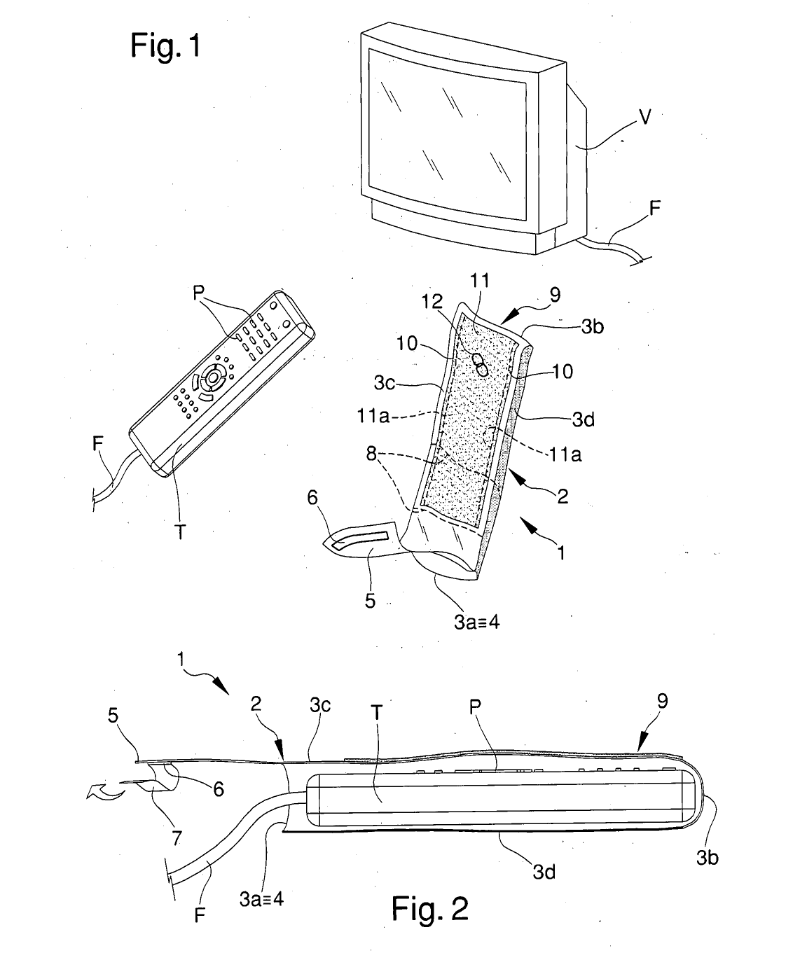

In the particular embodiment shown in FIG. 1, furthermore, the electronic appliance V is a TV set V but alternative embodiments are possible wherein the case 1 is used with remote control units T for controlling electronic devices of different types, e.g., to control Hi-Fi apparatus, lighting systems, to open/close doors and gates, etc.

The case 1 was designed in particular as a disposable device for containing the remote control units T in hotel bedrooms, but can also be used in exactly the same way in other environments, such as hospitals, clinics, homes and workplaces in general.

The case 1 comprises a cover wrapping 2 for covering the substantial totality of the remote control unit T; this means that the cover wrapping 2, once fitted over the remote control unit T, substantially covers its entire surface without leaving any part of it uncovered.

The cover wrapping 2 comprises a flexible bag 3a, 3b, 3c, 3d, having a fitting opening 4 for fitting the remote control unit T which can be closed by means of closing means 5, 6, 7.

More in detail, the flexible bag 3a, 3b, 3c, 3d comprises a tubular body having an open extremity 3a, suitable for defining and matching with a fitting opening 4, and a closed extremity 3b, opposite the open extremity 3a.

The flexibility of the flexible bag 3a, 3b, 3c, 3d permits using the remote control unit T when this is fitted in the case 1 by simply pressing the keys of the pushbutton panel P.

The flexibility of the flexible bag 3a, 3b, 3c, 3d, moreover, permits winding the remote control unit T completely with the electric wire F only coming out.

Usefully, the closing means 5, 6, 7 comprise a flap 5, extending from an edge of the open extremity 3a and which can be folded on the fitting opening 4, and a layer of adhesive material 6 for joining the flap 5 to the flexible bag 3a, 3b, 3c, 3d.

The layer of adhesive material 6, e.g., consists of a strip of glue temporarily covered by a protective tab 7, which is removable shortly before the closing of the case 1.

The flexible bag 3a, 3b, 3c, 3d and the flap 5 are made of a plastic material, e.g., HDPE (high-density polyethylene) with a thickness of 35-40 μm, to which can if necessary be added an additive suitable for making the cover wrapping 2 biodegradable, such as, e.g., the commercial product known by the brand name d2w®.

The flexible bag 3a, 3b, 3c, 3d has at least one sector which is at least partially transparent and can be placed in correspondence to the pushbutton panel P of the remote control unit T, to permit this to be viewed once the case 1 has been closed.

More in detail, in the particular embodiment of the invention shown in the illustrations, the flexible bag 3a, 3b, 3c, 3d is divided into a substantially transparent first face 3c and into a non-transparent second face 3d.

This subdivision makes it easier to recognise the front and back of the cover wrapping 2 so that, during the fitting of the remote control unit T in the case 1, the first face 3c is placed in correspondence to the pushbutton panel P of the remote control unit T.

The second face 3d can be usefully dedicated to printing wordings, drawings, advertising logos, instructions for the use of case 1, medical speciality indications and symbols or the like.

The cover wrapping 2 also comprises at least a segment with weakened section 8 suitable for more easily tearing off the cover wrapping 2 for the removal of the remote control unit T.

Once the flap 5 has been closed, in fact, the layer of adhesive material 6 creates a permanent adhesion on the flexible bag 3a, 3b, 3c, 3d and to remove the remote control unit T the flexible bag 3a, 3b, 3c, 3d must be torn, making it no longer usable for subsequent uses.

The segment with weakened section 8 can consist of a pre-cut line, in correspondence to which the thickness of the flexible bag 3a, 3b, 3c, 3d is reduced (e.g., 15-20 μm).

In combination or alternatively, the segment with weakened section 8 can consist of a succession of holes of sizes small enough to prevent, during use, direct contact of the user's hand with the remote control unit T and consider the substantial totality of the remote control unit T still substantially covered.

Preferably, the segments with weakened section 8 are more than one so as to guarantee the breaking of the cover wrapping 2 in several points and irrespective from how the flap 5 is folded on the flexible bag 3a, 3b, 3c, 3d.

The case 1 comprises a covering element 9, which is associated in a removable way with the cover wrapping 2 substantially in correspondence to its transparent sector and is suitable for preventing the pushbutton panel P from being viewed at least partially until the covering element 9 is removed from the cover wrapping 2.

In other words, the covering element 9 is a non-transparent item which, when joined to the cover wrapping 2, makes the pushbutton panel P impossible to be viewed and prevents the normal use of the remote control unit T because the user is not able to recognise its keys.

When the covering element 9 is removed, instead, the pushbutton panel P becomes visible and the remote control unit T can be freely employed by the user.

The covering element 9 is defined by a sheet element associable at least partially with the outer surface of the cover wrapping 2.

More in detail, the sheet element 9 is associable with the cover wrapping 2 by means of a technique selected from the list comprising: gluing, hot sealing of a plastic material, a combination of the two.

In other words the sheet element 9 can be glued and/or sealed at least partially to the cover wrapping 2.

Preferably, with the covering element 9 is combined an identification element 12, e.g. a sign, a symbol, a barcode or a holographic image shown on the covering element 9.

The identification element 12 can be used to show, e.g.:
the hotel brand;
an identification code, usable by the manufacturer of the cases 1 to recognise any counterfeited products;
indications for removing the covering element 9.

The covering element 9 comprises at least a part which can be glued and/or sealed on the outer surface of the cover wrapping 2.

In this respect, it is pointed out that the covering element 9 comprises at least a first portion 10, associated with the cover wrapping 2, and at least a second portion 11, removable by tearing off from the first portion 10 to permit the pushbutton panel P to be viewed.

More in detail, the covering element 9 comprises two first portions 10 associated along two opposite sides 11a of the second portion 11, wherein the opposite sides 11a are breakable for the removal of the second portion 11.

In particular, the first portions 10 are firmly associated (e.g., by gluing using a strong glue) with the cover wrapping 2 and suitable for remaining onto the cover wrapping 2 after the removal of the second portion 11 as proof of tampering, with tamper-evident function.

The first portions 10 are shaped to form two longitudinal strips, i.e., which extend parallel to the longitudinal direction of the cover wrapping 2.

The second portion 11, on the other hand, is without glue or is glued to the cover wrapping 2 by means of a weak glue, which permits its removal; in both cases, once the second portion 11 has been removed it cannot be reattached.

In the same way as on the cover wrapping 2, on the covering element 9 too, wordings, drawings, advertising logos, instructions for using the case 1, medical indications and symbols, or the like can be printed.

The case 1, finally, comprises at least a graphic element 13 which is shown on the transparent sector of the cover wrapping 2 and which, after the removal of the covering element 9, becomes visible as proof of tampering.

The graphic element 13, in practice, consists of a wording, a drawing, a symbol or anything else indicating to the user that the cover wrapping 2 has already been used.

In the embodiment of the invention shown in the figures, therefore, the case 1 has two tamper-evident systems: the first portions 10 and the graphic element 13.

Alternative embodiments, however, cannot be ruled out wherein only one of these two systems are provided.

In other words, solutions are envisaged wherein the graphic element 13 is not present and the tampering occurred is only proven by the first portions 10 which remain on the cover wrapping 2.

At the same time solutions are envisaged wherein the covering element 9 is totally removable from the cover wrapping 2 and the tampering occurred is only proven by the graphic element 13.

The operation of the present invention is the following.

The case 1 is distributed on the market as it appears in FIG. 1, with the covering element 9 integral and associated with the cover wrapping 2 and with the fitting opening 4 accessible from outside.

At the time of use, e.g. to cover the remote control unit T of a hotel room, the bedroom cleaning person introduces the remote control unit T through the fitting opening 4 and positions the pushbutton panel P on the side of the first face 3c (FIG. 2).

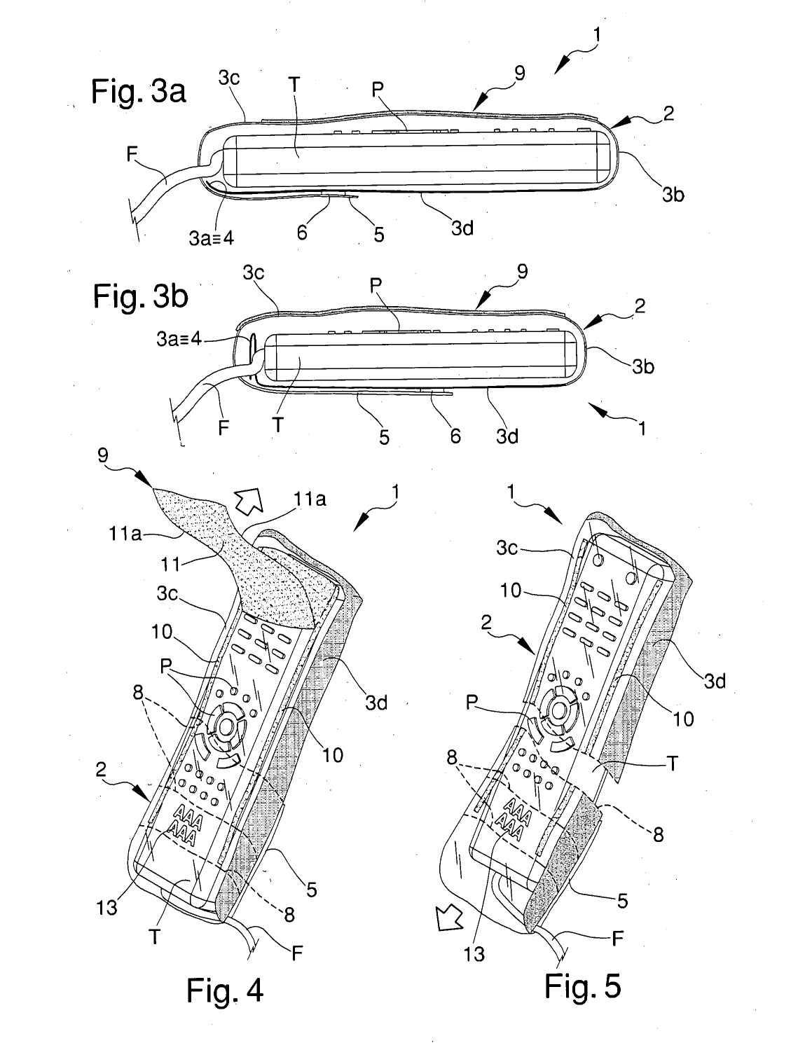

At this point, the cleaning person removes the protective tab 7 and folds the flap 5 on the fitting opening 4 to close the cover wrapping 2 around the remote control unit T (FIGS. 3a and 3b).

Usefully, the case 1 can be proposed in various shapes and sizes to adapt to the dimensions of the different remote control units T on the market.

It is underlined however that the particular shape of the case 1 permits quickly and easily adapting the length of the cover wrapping 2 to the length of the remote control unit T by simply folding the flap 5 on the flexible bag 3a, 3b, 3c, 3d.

Such property of the present invention is well illustrated in the FIGS. 3a and 3b, where the case 1 is shown in closing configuration covering two remote control units T of different dimensions.

Once the cover wrapping 2 has been closed, the remote control unit T is left inside the hotel room with the covering element 9 which is positioned on the transparent sector of the cover wrapping 2 and therefore prevents the pushbutton panel P from being viewed.

In such configuration, the remote control unit T is found by the user of the hotel room, who is therefore sure that no one before him/her can have used the remote control unit T and he/she is the first to use it after it has been fitted in the case 1.

To use the remote control unit T and the TV set V, the user removes the covering element 9 by tearing the second portion 11 off the first portions 10, which remain on the cover wrapping 2 to testify it has been used (FIG. 4).

Once the second portion 11 has been removed, the remote control unit T can be used normally by the user who is sure of handling a clean case 1 in conditions of utmost hygiene.

While cleaning the hotel bedroom, the cleaner replaces the already-used case 1 with a new one.

For this purpose, the cover wrapping 2 is necessarily removed by tearing it off, exploiting one or more segments with weakened section 8 which ensure easier breaking of the flexible bag 3a, 3b, 3c, 3d (FIG. 5).

Once the cover wrapping 2 has been removed, the breakage of the flexible bag 3a, 3b, 3c, 3d prevents its being used again, making necessary the use of a new case 1 and provides a further guarantee of the hygienic benefits of the present invention.

1. Case (1) for remote control units, comprising at least a cover wrapping (2) for covering the substantial totality of a remote control unit (T) having at least a pushbutton panel (P), said cover wrapping (2) comprising at least a sector which is at least partially transparent and can be placed in correspondence to said pushbutton panel (P) of the remote control unit (T) to permit the view of said pushbutton panel (P), wherein said case (1) comprises at least a covering element (9) which is associated in a removable way with said cover wrapping (2) substantially in correspondence to said sector and suitable for preventing said pushbutton panel (P) from being viewed as long as said covering element (9) is removed from said cover wrapping (2).

2. Case (1) according to the claim 1, wherein said covering element (9) comprises a sheet element associable at least partially with the outer surface of said cover wrapping (2).

3. Case (1) according to claim 2, wherein said sheet element (9) is associable with said cover wrapping (2) by means of a technique chosen from the list comprising: gluing, hot sealing of a plastic material, a combination of the two.

4. Case (1) according to claim 1, wherein said covering element (9) comprises at least an identification element (12).

5. Case (1) according to claim 1, wherein said covering element (9) comprises at least a first portion (10) associated with said cover wrapping (2) and at least a second portion (11) removable by tearing off from said first portion (10) to permit the view of said pushbutton panel (P).

6. Case (1) according to the claim 5, wherein said first portion (10) is firmly associated with said cover wrapping (2) and is suitable for remaining onto said cover wrapping (2) after the removal of said second portion (11) as proof of tampering.

7. Case (1) according to the claim 5 wherein said covering element (9) comprises at least two of said first portions (10) associated along two opposite sides (11a) of said second portion (11), said opposite sides (11a) being breakable for the removal of said second portion (11).

8. Case (1) according to claim 1, wherein said case (1) comprises at least a graphic element (13) which is marked on said sector and which, after the removal of said covering element (9), becomes visible as proof of tampering.

9. Case (1) according to claim 1, wherein said cover wrapping (2) comprises at least a flexible bag (3a, 3b, 3c, 3d).

10. Case (1) according to claim 1, wherein said cover wrapping (2) comprises at least a fitting opening (4) for fitting said remote control unit (T), said fitting opening (4) being closable by means of closing means (5, 6, 7).

11. Case (1) according to the claim 10, wherein said closing means (5, 6, 7) comprise at least a flap (5) foldable on said fitting opening (4) and at least a layer of adhesive material (6) for joining said flap (5) to said cover wrapping (2).

12. Case (1) according to the claim 10, wherein said cover wrapping (2) comprises at least a tubular body having an open extremity (3a) suitable for defining said fitting opening (4) and a closed extremity (3b) opposite said open extremity (3a).

13. Case (1) according to claim 1, wherein said cover wrapping (2) is divided into a substantially transparent first face (3c) and into a non-transparent second face (3d), said first face (3c) being placed in correspondence to said pushbutton panel (P) of the remote control unit (T).

14. Case (1) according to claim 1, wherein said cover wrapping (2) comprises at least a segment with weakened section (8) suitable for making easier the tearing off of said cover wrapping (2) for the removal of said remote control unit (T).
